(19) United States
(12) Patent Application Publication
(10) Pub. No.: US 2009/0076907 A1
(43) Pub. Date: Mar. 19, 2009

(54) Method and system for providing media content

(76) Inventors: Louis Robert Litwin, Edison, NJ (US); Purvin Bibhas Pandit, Somerset, NJ (US); Donald Lee Hornback, Indianapolis, IN (US)

Correspondence Address: Robert D. Shedd;Thomson Licensing LLC, PO Box 5312, PRINCETON, NJ, 08543-5312, US

(21) Appl. No.: 11/918,686

(22) PCT Filed: Apr. 21, 2005
(86) PCT No.: PCT/US2005/013697

§ 371 Date: Oct. 17, 2007

(51) Int. Cl. G06Q 30/00

(52) U.S. Cl. 705/14

(57) ABSTRACT

A technique for providing media content such as advertisements enables, among other things, advertisers to schedule their advertisements more effectively and accurately determine the number of consumers that receive their advertisements. According to an exemplary embodiment, a method for providing media content via a system includes steps of detecting a number of user devices logged onto the system, and providing the media content to the user devices responsive to the detected number.

### BACKGROUND OF THE INVENTION

1. Field of the Invention

The present invention generally relates to a technique for providing media content, and more particularly, to a technique for providing media content such as advertisements that enables, among other things, advertisers to schedule their advertisements more effectively and accurately determine the number of consumers that receive their advertisements.

2. Background Information

With traditional broadcast television, advertisers generally schedule advertisements based on the time of day. For example, advertisers may schedule their advertisements to be presented during so-called “primetime” hours in which the viewing audience is expected to be at its largest. With traditional broadcast television, such primetime hours generally occur at well-known times each day. For example, the weeknight hours from 8 pm to 10 pm may be considered primetime hours for television broadcasts since the largest viewing audiences are generally present during that time period.

While primetime hours for television broadcasts are generally known and predictable, primetime hours for other types of networks may vary. For example, with mobile wireless networks, primetime hours may occur during “rush hour” as people are watching and/or listening to media as they commute to and from work via public or private transportation. However, if there is a traffic jam (i.e., people sitting idle in their vehicles) or a delay with commuter transportation, the size of the mobile media audience can suddenly increase at unpredictable times. Accordingly, primetime hours may vary with such media networks. Because of the variability and unpredictability in audience size with networks such as mobile wireless networks, it is often difficult for advertisers to know when to schedule their advertisements in order to reach the maximum number of consumers, and/or to accurately determine the number of the consumers that receive their advertisements.

Accordingly, there is a need for a technique for providing media content such as advertisements which addresses the foregoing problems, and thereby enables, among other things, advertisers to schedule their advertisements more effectively and accurately determine the number of consumers that receive their advertisements. The present invention addresses these and/or other issues.

### SUMMARY OF THE INVENTION

In accordance with an aspect of the present invention, a method for providing media content via a system is disclosed. According to an exemplary embodiment, the method comprises steps of detecting a number of user devices logged onto the system, and providing the media content to the user devices responsive to the detected number.

In accordance with another aspect of the present invention, a system is disclosed. According to an exemplary embodiment, the system comprises storage means for storing media content, and detection means for detecting a number of user devices logged onto the system. The system provides the media content to the user devices responsive to the detected number.

In accordance with yet another aspect of the present invention, a user interface for enabling advertising is disclosed. According to an exemplary embodiment, the user interface comprises a first data field including a number range of user devices logged onto a system, and a second data field including an advertisement to be provided to the user devices corresponding to the number range.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exemplary environment suitable for implementing the present invention;

FIG. 2 is a diagram providing further details of the server system of FIG. 1 according to an exemplary embodiment of the present invention;

FIG. 3 is a flowchart illustrating steps according to an exemplary embodiment of the present invention; and

FIG. 4 is a diagram illustrating a user interface according to an exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

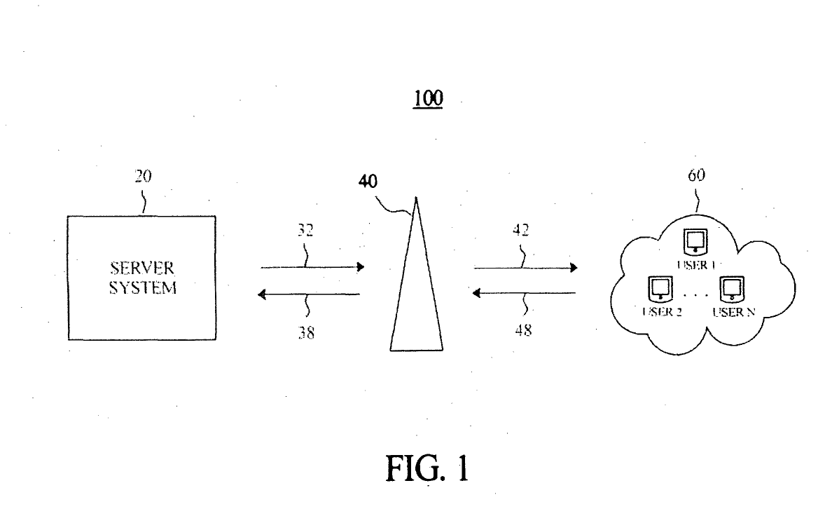

Referring now to the drawings, and more particularly to FIG. 1, an exemplary environment 100 suitable for implementing the present invention is shown. Environment 100 of FIG. 1 comprises server system 20, signal receiver/transmitter 40, and network 60. In FIG. 1, server system 20 includes one or more individual servers and is operative to transmit signals including audio and/or video signals to signal receiver/transmitter 40 via a downstream link 32. As will be described later herein, such audio and/or video signals may include advertisements. Signal receiver/transmitter 40 is operative to re-transmit the signals received from server system 20. to N user devices of network 60 via a downstream link 42 (where N is an integer).

Signal receiver/transmitter 40 is also operative to receive signals from the N user devices of network 60 via an upstream link 48, and to provide such signals to server system 20 via an upstream link 38. Downstream links 32 and 42 and upstream links 38 and 48 may each include one or more individual channels having prescribed bandwidths, and may comprise wired and/or wireless mediums. According to an exemplary embodiment, upstream links 38 and 48 may be used as a back channel through which the N user devices of network 60 transmit signals to server system 20 via signal receiver/transmitter 40. As will be described later herein, the signals transmitted from the N user devices to server system 20 via this back channel may be used to determine the number of user devices currently logged onto server system 20, and this number represents the current audience for receiving media content including advertisements provided from server system 20.

According to an exemplary embodiment, signal receiver/transmitter 40 is embodied as a wireless multimedia broadcast tower, but could be embodied as any type of device or apparatus (e.g., media bridge, etc.) capable of receiving and transmitting wired and/or wireless signals. Also according to an exemplary embodiment, network 60 is embodied as a mobile wireless network having N users and corresponding user devices embodied as mobile wireless output devices (e.g., hand-held wireless devices, cellular telephones, lap-top computers, etc.) capable of providing audio and/or video outputs including advertisements responsive to audio and/or video signals provided from server system 20. Network 60 could, however, be embodied as another type of network such as an intranet or the internet, and its user devices could be embodied as other types of output devices (e.g., desktop computers, television signal receivers, etc.) capable of providing audio and/or video outputs including advertisements responsive to audio and/or video signals provided from server system 20.

According to principles of the present invention, server system 20 provides media content in audio and/or video format to the N user devices of network 60 based on factors including the number of such user devices logged onto server system 20. For purposes of example and explanation, the present invention is described herein with a particular emphasis on media content in the form of advertisements. However, it is noted that the present invention is not limited to media content in the form of advertisements, and that server system 20 may provide other types of media content (e.g., television programs, radio programs, etc.) to the N user devices of network 60 based on factors including the number of such user devices logged onto server system 20.

According to an exemplary embodiment, advertisers may purchase advertising slots based, at least in part, on the size of the audience as represented by the number of user devices logged onto server system 20, instead of purchasing advertising slots based on the time(s) of day that advertisements are presented. In this manner, advertising slots may be made available for different levels of audience size and the price/fee for a given advertising slot may be proportional to the audience size. For example, the fee to purchase an advertising slot when the audience size is between 100 and 250 users may be relatively low, while the fee to purchase an advertising slot when the audience size is between 2500 to 5000 users may be significantly higher. Therefore, a business with a relatively small advertising budget may only be able to purchase an advertising slot for a relatively small audience size, but would still reap the benefit of being able to distribute its advertisement(s) via server system 20. Advertisers may also purchase multiple advertising slots for different audience sizes.

According to an exemplary embodiment, other factors may also be used to establish the advertising fees paid by advertisers. For example, factors such as the total number of times an advertisement is provided, and/or the time interval between each time an advertisement is provided may be used to establish the advertising fees paid by an advertiser. In this manner, the advertising fee may increase as the number of times an advertisement is provided increases and/or the time interval between each time an advertisement is provided decreases. Also according to an exemplary embodiment, the type of media content (e.g., cartoon, sports, news, adult, etc.) an advertisement is inserted into may also be used to establish the advertising fees paid by advertisers. For example, an advertisement for a toy provided during a cartoon may be charged one fee, while an advertisement for an athletic shoe provided during a sporting event may be charged another fee. By specifying the type of media content, an advertiser may infer the demographics of the potential audience for its advertisement, which is important for targeted marketing purposes. Further details regarding the aforementioned aspects of the present invention will be provided later herein.

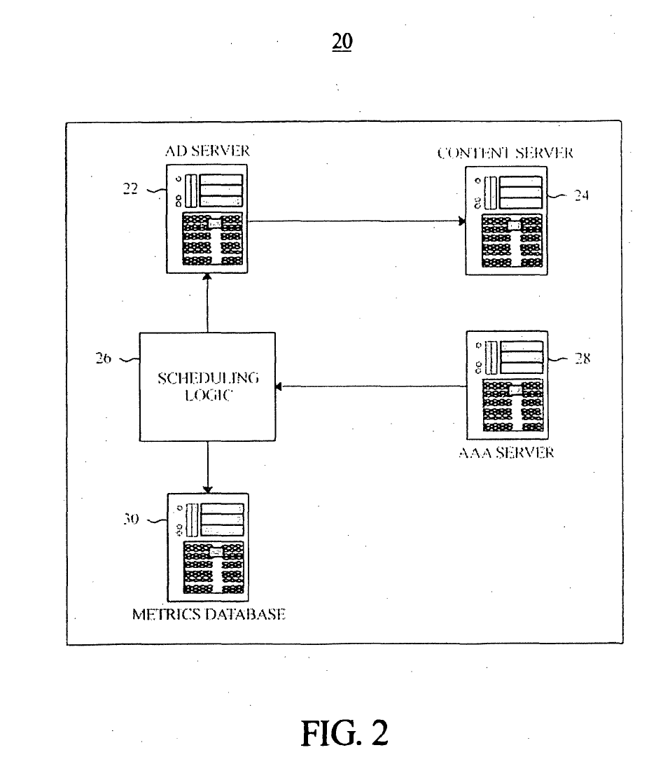

Referring to FIG. 2, a diagram providing further details of server system 20 of FIG. 1 according to an exemplary embodiment of the present invention is shown. Server system 20 of FIG. 2 comprises ad server 22, content server 24, scheduling logic 26, authentication, accounting and authorization (AAA) server 28, and metrics database 30. While the foregoing elements of server system 20 are represented as individual elements in FIG. 2, it should be intuitive to those skilled in the art that the functions of such elements may be combined into one or more elements in accordance with design choice. Accordingly, the design of server system 20 shown in FIG. 2 is exemplary only, and is not intended to limit the present invention in any manner. Moreover, communication lines other than those expressly shown in FIG. 2 may exist and be used to transmit signals such as control signals.

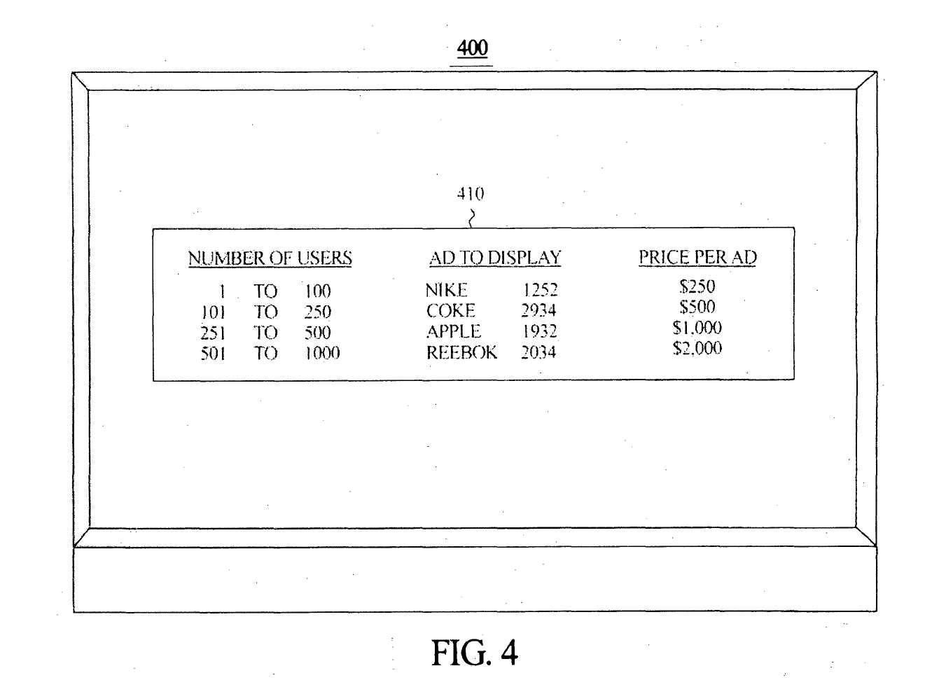

Ad server 22 is operative to store data including advertisements that are provided to user devices of network 60 according to principles of the present invention. According to an exemplary embodiment, ad server 22 stores advertisements from one or more advertisers and enables such advertisements to be provided to user devices of network 60 based on factors including the number of such user devices logged onto server system 20. Ad server 22 also provides a user interface, such as the one shown in FIG. 4, which enables an operator to input, 115 retrieve and observe various advertising parameters (e.g., number of users logged onto server system 20, advertisement display order information, price/fee information, etc.) used according to the present invention. Further details regarding the aforementioned aspects of the present invention will be provided later herein.

Content server 24 is operative to insert advertisements provided from ad server 22 into one or more broadcast streams of audio and/or video signals that are provided to user devices of network 60. According to an exemplary embodiment, content server 24 detects commercial breaks and inserts advertisements into one or more individual channels of downstream link 32 during each commercial break. Signal receiver/transmitter 40 then provides the advertisements to user devices of network 60 via downstream link 42.

Scheduling logic 26 is operative to receive and process data to facilitate advertising according to principles of the present invention. According to an exemplary embodiment, scheduling logic 26 receives data indicating the number of user devices logged onto server system 20 from AAA (Authentication, Accounting, and Authorization) server 28. Scheduling logic 26 may then process this data (e.g., perform a moving average or compute the number of users at a predetermined time such as one minute before a commercial break or at the time a commercial break signal have been received) to determine the applicable advertising slot based on the number of user devices logged onto server system 20 and provide data indicating the result of this processing to ad server 22. Ad server 22 then selects the next advertisement to be provided based on the received data, and provides the selected advertisement to content server 24 for insertion into one or more broadcast streams of audio and/or video signals. Scheduling logic 26 also provides data indicating the number of user devices logged onto server system 20, and other advertising-related data to metrics database 30 for storage.

AAA server 28 is operative to perform functions including authentication, accounting and authorization functions of server system 20. According to an exemplary embodiment, user devices may log onto server system 20 and thereby request access to audio and/or video channels (i.e., free or pay channels) provided by server system 20 by transmitting signals to AAA server 28 via a back channel comprised of upstream links 38 and 48. In this manner, AAA server 28 is able to detect the number of user devices logged onto server system 20 and/or each channel thereof at any given time. AM server 28 periodically provides data to scheduling logic 26 including the number of user devices currently logged onto server system 20 and/or the individual channels thereof.

Metrics database 30 is operative to store data including data related to the advertisements provided to user devices of network 60 according to principles of the present invention. According to an exemplary embodiment, metrics database 30 stores data including the number of user devices logged onto server system 20 at each commercial break, the date/time that each advertisement is provided, the number of times each advertisement is provided, etc. The data stored in metrics database 30 may be accessed by an operator and used for purposes such as billing, advertising sales, etc.

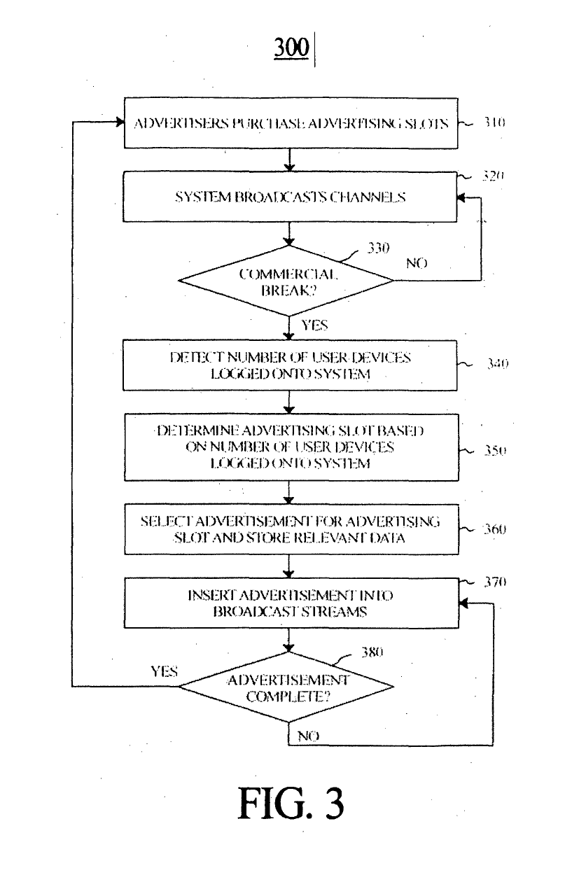

To facilitate a better understanding of the present invention, an example will now be provided. Referring to FIG. 3, a flowchart 300 illustrating steps according to an exemplary embodiment of the present invention is shown. For purposes of example and explanation, the steps of FIG. 3 will be described with reference to the elements of FIG. 1 and server system 20 of FIG. 2, and media content in the form of advertisements. The steps of FIG. 3 are exemplary only, and are not intended to limit the present invention in any manner.

At step 310, advertisers may purchase advertising slots for advertisements to be provided via server system 20. According to an exemplary embodiment, the price/fee charged to advertisers for providing a given advertisement varies based on the number of user devices logged onto server system 20. Accordingly, instead of purchasing advertising slots based on the time(s) of day that advertisements are presented, advertisers may purchase advertising slots at step 310 based, at least in part, on the size of the audience as represented by the number of user devices logged onto server system 20. As previously indicated herein, other factors may also be used to establish the advertising fees paid by advertisers. According to an exemplary embodiment, factors such as the total number of times an advertisement is provided, the time interval between each time an advertisement is provided, and/or the type of media content (e.g., cartoon, sports, news, adult, etc.) an advertisement is inserted into may also be used to establish the advertising fees paid by an advertiser at step 310.

FIG. 4 is a diagram 400 illustrating a user interface 410 according to an exemplary embodiment of the present invention. User interface 410 is exemplary only, and is not intended to limit the present invention in any manner. User interface 410 includes a plurality of data fields and illustrates, among other things, how advertising fees may be charged to advertisers at step 310 of FIG. 3, and how those fees may vary based on the number of users logged onto server system 20. As indicated by user interface 410, an advertisement for Nike® may be provided when the number of user devices logged onto server system 20 is in the range from 1 to 100 (i.e., the first user range in FIG. 4), and the price charged each time that advertisement is provided (i.e., aired) is $250. Alternatively, an advertisement for Reebok® may be provided when the number of user devices logged onto server system 20 is in the range from 501 to 1000 (i.e., the fourth user range in FIG. 4), and the price charged each time that advertisement is provided is $2,000. In FIG. 4, the numbers (i.e., 1252, 2934, 1932 and 2034) next to each ad listing are specific identifiers for advertisements since there may be more than one advertisement for each brand/product. For example, there may be more than one advertisement for Coke.

Advertisers may also purchase multiple advertising slots for different audience sizes at step 310. For example, a given advertiser may purchase an advertising slot for when the number of user devices logged onto server system 20 is in the range from 1000 to 2500, and may also purchase an advertising slot for when the number of user devices logged onto server system 20 is in the range from 2500 to 5000. Also, in order to prevent only a single advertisement from appearing at a given user range, it may be required that several advertisements be allocated for a given user range at step 310 before any advertisements are provided (i.e., aired) to that user range. For example, it may be required that 10 different advertisements be allocated for the user range from 250 to 500 before advertisements are provided to that user range. As will be described later herein, advertisements may be provided from server system 20 on a round-robin basis for a given user range when multiple advertisements have been allocated for that given user range. Although not expressly shown in FIG. 3, the purchase of advertising slots at step 310 may occur at any time during the process represented in FIG. 3.

At step 320, server system 20 broadcasts channels to user devices of network 60. According to an exemplary embodiment, content server 24 of server system 20 broadcasts one or more channels of audio and/or video signals to those user devices of network 60 logged onto server system 20 via signal receiver/transmitter 40 and downstream links 32 and 42.

At step 330, a determination is made as to whether it is time for a commercial break. According to an exemplary embodiment, content server 24 detects whenever a commercial break is scheduled to occur on each broadcast channel based on the normal progression of the audio and/or video content being broadcast. If the determination at step 330 is negative, process flow loops back to step 320 where content server 24 continues to broadcast channels to user devices of network 60.

If the determination at step 330 is positive, process flow advances to step 340 where the number of user devices of network 60 logged onto server system 20 is detected. According to an exemplary embodiment, AAA server 28 detects the number of user devices of network 60 logged onto each channel of server system 20 by receiving signals from such user devices via signal receiver/transmitter 40 and upstream links 38 and 48 when such user devices log onto server system 20. As previously indicated herein, user devices of network 60 may log onto server system 20 and thereby request access to audio and/or video channels (i.e., free or pay channels) provided by server system 20 by transmitting signals to AAA server 28 via a back channel comprised of upstream links 38 and 48. In this manner, AAA server 28 is able to detect the number of user devices logged onto each channel of server system 20 at step 340.

Next, at step 350, the applicable advertising slot is determined based on the number of user devices of network 60 logged onto server system 20. According to an exemplary embodiment, scheduling logic 26 receives data indicating the number of user devices of network 60 logged onto server system 20 from AAA server 28 and processes this data (e.g., performs a moving average or compute the number of users at a predetermined time such as one minute before a commercial break or at the time a commercial break signal have been received) to determine the applicable advertising slot. For example, scheduling logic 26 may determine that the advertising slot corresponding to a user range from 1000 to 2500 is applicable. Data indicating the result of the processing performed by scheduling logic 26 at step 350 is also provided to ad server 22.

At step 360, an advertisement for the advertising slot is selected and relevant data is stored. According to an exemplary embodiment, ad server 22 selects the next advertisement to be provided based on the data received from scheduling logic 26 at step 350. As previously indicated herein, advertisements may be provided on a round-robin basis for a given user range when multiple advertisements have been allocated for that given user range. For example, assume 10 different firms purchased the advertising slot for the 250 to 500 user range at step 310. In this situation, assuming that the user range stays constant at 250 to 500 for 3 consecutive commercial breaks, ad server 22 selects the advertisement for the first firm at the first commercial break, selects the advertisement for the second firm at the second commercial break, and selects the advertisement for the third firm at the third commercial break. This process continues in a round-robin fashion for each commercial break in which the user range is from 250 to 500 until an advertisement for each of the 10 different firms is sequentially selected. Thereafter, the process repeats itself. If the situation occurs where advertisements for the first 5 of the 10 firms have been selected, and then the number of users logged onto server system 20 changes to a different user range (e.g., from the 250 to 500 range to the 501 to 1000 range) at the next commercial break, an advertisement for the new user range (i.e., the 501 to 1000 range) is selected at that commercial break. Then, the next time the original user range of 250 to 500 is present at a commercial break, ad server 22 selects the advertisement for the sixth firm, then the seventh firm, and so on. Also, if an eleventh firm purchases an advertising slot during this period, this firm's advertisement would be selected after the advertisement for the tenth firm and before wrapping around to the advertisement for the first firm.

Also at step 360, relevant advertising-related data is stored. According to an exemplary embodiment, scheduling logic 26 provides data including the number of user devices logged onto server system 20 at each commercial break, the date/time that each advertisement is provided, the number of times each advertisement is provided, etc. The data stored in metrics database 30 may be accessed by an operator and used for purposes such as billing, advertising sales, etc.

At step 370, the advertisement selected at step 360 is inserted into one or more broadcast streams. According to an exemplary embodiment, content server 24 inserts the selected advertisement provided from ad server 22 into one or more broadcast streams of audio and/or video signals. According to principles of the present invention, advertisements can be inserted at step 370 using at least two different techniques. According to the first technique, a selected advertisement is inserted into all broadcast streams (i.e., channels) provided from content server 24 at step 370, regardless of the type of content included in those streams. This technique is relatively easy to implement since server system 20 only needs to track the number of user devices logged onto server system 20 (as described herein), and does not need to track the allocation of user devices to the various audio and/or video channels provided by server system 20. It is noted that this first technique does not enable targeted advertising to be performed since the same advertisement is provided to users tuned to, for example, a cartoon channel, a news channel and a sports channel.

According to the second technique, different advertisements are inserted into different broadcast streams (i.e., channels) provided from content server 24 at step 370. For example, an advertisement for a new toy may be inserted into a cartoon channel, and an advertisement for a new athletic shoe may be inserted into a sports channel. In order to implement this second technique, ad server 22 needs to keep track of the number of user devices logged onto each specific media channel is provided by server system 20 (e.g., 100 user devices logged onto the cartoon channel, 125 user devices logged onto the sports channel, etc.). As previously indicated herein, AAA server 28 is able to detect the number of user devices logged onto each channel of server system 20 at any given time, and periodically provides this data to scheduling logic 26. Accordingly, the aforementioned second technique for inserting advertisements at step 370 can be readily implemented using server system 20 as previously described herein. While the implementation of the second technique is slightly more complex than the first technique in that ad server 22 needs to keep track of when users change channels, it provides the advantage of allowing for targeted advertising.

At step 380, a determination is made as to whether the advertisement is complete. According to an exemplary embodiment, content server 24 detects when the advertisement is complete by detecting the normal progression of the advertisement. If the determination at step 380 is negative, process flow loops back to step 370 where the advertisement continues to be inserted into the broadcast stream until the advertisement is complete. Once the advertisement is complete, process flow loops back to step 310 where advertisers may purchase additional advertising slots, and process flow continues in the aforementioned manner.

As described herein, the present invention includes a technique for providing media content such as advertisements that enables, among other things, advertisers to schedule their advertisements more effectively and accurately determine the number of consumers that receive their advertisements. It is noted that the advertising techniques described herein are not mutually exclusive from existing advertising techniques. Accordingly, a service provider can implement the present invention, and also allow firms to purchase advertising slots based solely on the time of day as well.

While this invention has been described as having a preferred design, the present invention can be further modified within the spirit and scope of this disclosure. For example, instead of using a fixed program schedule, a service provider may select a next program according to the number of users for a current broadcast program. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for providing media content via a system, comprising:
detecting a number of user devices logged onto said system; and
providing said media content to said user devices responsive to said detected number.

2. The method of claim 1, wherein said detecting step is performed responsive to a commercial break.

3. The method of claim 1, wherein said detecting step includes receiving signals from said user devices via a back channel.

4. The method of claim 1, wherein said user devices include mobile wireless output devices.

5. The method of claim 1, wherein said media content includes an advertisement.

6. The method of claim 5, wherein said advertisement is selected from a plurality of advertisements according to said detected number.

7. The method of claim 5, further comprising the step of charging an advertiser a fee for providing said advertisement, and wherein said fee is based on said number of user devices logged onto said system.

8. The method of claim 7, wherein said fee is further based on a number of times said advertisement is provided.

9. The method of claim 7, wherein said fee is further based on a type of media content said advertisement is inserted into.

10. A system, comprising:
storage means for storing media content;
detection means for detecting a number of user devices logged onto said system; and
wherein said system provides said media content to said user devices responsive to said detected number.

11. The system of claim 10, wherein said number is detected responsive to a commercial break.

12. The system of claim 10, wherein said number is detected by receiving signals from said user devices via a back channel.

13. The system of claim 10, wherein said user devices include mobile wireless output devices.

14. The system of claim 10, wherein said media content includes an advertisement.

15. The system of claim 14, wherein said advertisement is selected from a plurality of advertisements according to said detected number.

16. The system of claim 14, wherein an advertiser is charged a fee for providing said advertisement, and said fee is based on said number of user devices logged onto said system.

17. The system of claim 16, wherein said fee is further based on a number of times said advertisement is provided.

18. The system of claim 16, wherein said fee is further based on a type of media content said advertisement is inserted into.

19. A user interface for enabling advertising, comprising:
a first data field including a number range of user devices logged onto a system; and
a second data field including an advertisement to be provided to said user devices corresponding to said number range.

20. The user interface of claim 19, further comprising a third data field including a fee to be charged to an advertiser each time said advertisement is provided.

21. The user interface of claim 20, wherein:
said first data field includes a plurality of number ranges of user devices logged onto said system;
said second data field includes a plurality of advertisements to be provided to said user devices corresponding to said plurality of number ranges; and
said third data field includes a plurality of fees to be charged to advertisers each time said advertisements are provided.

22. The user interface of claim 21, wherein said advertisements each include a numeric identifier.
